(19) United States
(12) Patent Application Publication
(10) Pub. No.: US 2010/0058486 A1
(43) Pub. Date: Mar. 4, 2010

(54) METHOD FOR SECURE ACCESS TO AND SECURE DATA TRANSFER FROM A VIRTUAL SENSITIVE COMPARTMENTED INFORMATION FACILITY (SCIF)

(75) Inventors: George C. Wilson, Austin, TX (US); Daniel H. Jones, Round Rock, TX (US); Emily J. Ratliff, Austin, TX (US); Thomas G. Lendacky, Austin, TX (US)

Correspondence Address: IBM CORPORATION (ACCSP);c/o Suiter Swantz pc llo, 14301 FNB Parkway, Suite 220, Omaha, NE, 68154, US

(73) Assignee: International Business Machines Corporation, Armonk, NY (US)

(21) Appl. No.: 12/200,223

(22) Filed: Aug. 28, 2008

(51) Int. Cl. G06F 21/00

(52) U.S. Cl. 726/28

(57) ABSTRACT

The present disclosure is directed to a method for limiting access to a virtual sensitive compartmented information facility (SCIF) and secure transport of information between two virtual SCIFs. The method may comprise creating a virtual SCIF, allowing access to the to the virtual SCIF to only those virtual subjects having the proper security clearance as analyzed by an access rule set loaded into an object request broker, creating a second virtual SCIF, creating a key lockable secure container to transport the information from the first virtual SCIF to the second virtual SCIF, and restricting access to the key to unlock the secure container in the second virtual SCIF.

### TECHNICAL FIELD

The present disclosure generally relates to the field of computer programming, and more particularly to a transportation method and facility for classified information in virtual worlds.

### BACKGROUND

Virtual world applications have become prominent of late. However, they lack the security measures applied to modern computing systems and may not be used to secure classified information. One access control model that would add the ability to handle classified information in virtual worlds is Multi-Level Security (MLS). MLS may be defined as the use of computer based software to permit or deny access to multiple levels of classified information simultaneously by users with various clearance levels. Users may be subject to a set of access control rules to determine the access limit (e.g the Bell-LaPadula model using security labels to define an access limit). MLS may prevent leakage of confidential information from higher level to lower levels and users (virtual subjects) only have access to compartments (virtual objects) to which they may be authorized.

MLS has a well-known set of characteristics. One aspect of providing MLS is that classified information may not be downgraded and potentially disclosed. Other security models, such as Discretionary Access Control (DAC) have been applied to virtual worlds to some extent and suffer from traditional DAC shortcomings. For example, programs run by a subject may be indistinguishable from the subject, information may be accidentally leaked, and malicious software may downgrade information.

A sensitive compartmented information facility (SCIF) may be defined as a secure enclosed area within a building used to discuss and exchange classified data. Only those with sufficient clearance may enter a particular SCIF. A virtual SCIF may have internal characteristics that reflect a sensitivity level but may have no external indications that it may be a SCIF. Data communicated within a virtual SCIF may not be disclosed to those parties without clearance. Data must not be allowed to leak from the SCIF.

The virtual SCIF describes a method for creating secure rooms in a virtual world. However, data must be securely transferable between virtual SCIFs. Classified objects may be transported by non-cleared subjects by storing them in a special secure container that has no markings that indicate its contents and that may not be opened except in the designated destination virtual SCIF by a trusted guard or, in the case of identical virtual SCIFs, a subject in the destination virtual SCIF that may dominate the classification of all data in the secure container. Policy governs how data may be transmitted between virtual SCIF domains.

### SUMMARY

The present disclosure is directed to a method for limiting access to a virtual sensitive compartmented information facility (SCIF) and transporting information between multiple SCIFs. The method comprises creating a virtual SCIF, the virtual SCIF augmented with a SCIF security label; augmenting a virtual subject with a subject security label; receiving a request for access to the virtual SCIF from the virtual subject; loading an access rule set into an object request broker; relaying the request for access to the object request broker; receiving a reply from the object request broker of a comparison of the SCIF security label to the subject security label in accordance with the access rule set; granting access to the virtual SCIF to the virtual subject if the request conforms to the access rule set; and denying access to the virtual SCIF to the virtual subject if the request does not conform to the access rule set. designating a first virtual SCIF, the first virtual SCIF augmented with a first security label and overseen by a first virtual SCIF owner; designating a second virtual SCIF, the second virtual SCIF augmented with a second security label and overseen by a second virtual SCIF owner; receiving a request from a virtual subject for transport of information from the first virtual SCIF to the second virtual SCIF; creating a secure container to transport the information; placing the information in the secure container; locking the secure container with a key; transporting the secure container from the first virtual SCIF to the second virtual SCIF; restricting access to the key in the second virtual SCIF, further including: loading an access rule set into an object request broker; receiving a request for access to the key in the second virtual SCIF from the second virtual SCIF owner; relaying the request for access to the object request broker; receiving a reply from the object request broker of a comparison of the first security label to the second security label in accordance with the access rule set; granting access to the key only if the secure container is in the second virtual SCIF; granting access to the key to the second virtual SCIF owner if the reply conforms to the access rule set; and denying access to the key to the second virtual SCIF owner if the reply does not conform to the access rule set.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flowchart representing a method for limiting access to a virtual sensitive compartmented information facility (SCIF);

FIG. 2 is a flowchart representing a method for secure transport of information between multiple virtual sensitive compartmented information facilities (SCIF).

### DETAILED DESCRIPTION

Reference will now be made in detail to the subject matter disclosed, which is illustrated in the accompanying drawings.

The present disclosure uses a new method of multi level security to limit access to information located in virtual sensitive compartmented information facilities which exist in a virtual world. Prior art security products may not offer the level of confidence for secure access to classified information required by many users. The present disclosure offers confident access in its use of a reference monitor in an object request broker to analyze access requests.

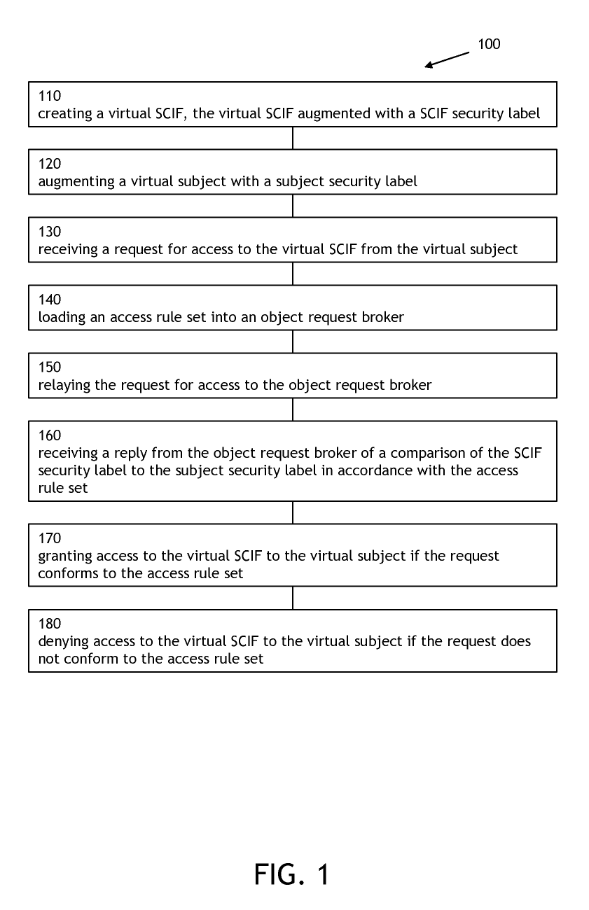

FIG. 1 shows a flowchart indicating method 100 for limiting access to a virtual sensitive compartmented information facility (SCIF). Method 100 may create a virtual SCIF, the virtual SCIF augmented with a SCIF security label 110. Method 100 may augment a virtual subject with a subject security label 120. The system objects that represent virtual subjects and virtual objects may be augmented to have respective security labels. In one embodiment, the security labels may be strings that represent the classification level and compartment set. Method 100 may receive a request for access to the virtual SCIF from the virtual subject 130. Method 100 may load an access rule set into an object request broker 140. The object request broker may maintain a reference monitor to analyze a request for access. The reference monitor may determine whether or not virtual subjects may access virtual objects. The access rule set 140 may conform to a policy based rule standard (e.g., based on Bell-LaPadula (BLP) rules limiting access to classified material to those with a clearance level equal to or higher than the material accessed).

The access rule set may be violated in some circumstances. A virtual subject (person) and a virtual object (classified data) may each be represented by a system object. A separate attribute in the system object representing the virtual subject may designate the virtual subject as trusted. A separate attribute in the system object representing the virtual object may designate the virtual object as trusted. Only trusted virtual subjects may violate the BLP rules. Only trusted objects may be manipulated and reclassified by a trusted virtual subject.

Method 100 may relay the request for access to the object request broker 150 for analysis under the access rule set. Method 100 may receive a reply from the object request broker of a comparison of the SCIF security label to the subject security label in accordance with the access rule set 160. Method 100 may grant access to the virtual SCIF to the virtual subject if the request conforms to the access rule set 170 or deny access to the virtual SCIF to the virtual subject if the request does not conform to the access rule set 180.

In one embodiment, virtual elevators may represent the ability to move between sensitivity levels. Floors may represent hierarchical clearance levels and rooms may represent non-hierarchical compartments. Elevators may display buttons corresponding to a sensitivity level that the viewing virtual subject is cleared to see. For example, virtual subject A may see buttons 1-4, whereas virtual subject B may see buttons 1-7. Invisible buttons may be effectively nonexistent. It is possible for a plurality of virtual buildings to be virtual SCIFs however, only floors and doors the viewing virtual subject is cleared to see may be visible. For example, if multiple virtual subjects enter an elevator, only the levels common to all virtual subjects in the elevator may be visible to all virtual subjects. Subjects cleared to higher levels may still see all the buttons they may be cleared to see but may not select those outside the common buttons until the lower cleared virtual subject exits the elevator. Likewise, within a level, only rooms representing compartments to which the viewing virtual subject is cleared may be visible. The elevator, door, and floor representation is one of several possible embodiments.

The present disclosure also uses a new method of multi level security to permit secure transfer of information between two virtual sensitive compartmented information facilities which exist in a virtual world. Prior art security products do not offer the level of confidence for secure transport of classified information required by many users. The present disclosure offers confident transport in its use of a reference monitor in an object request broker to analyze transportation requests and restricting access to information once the information has arrived at the destination.

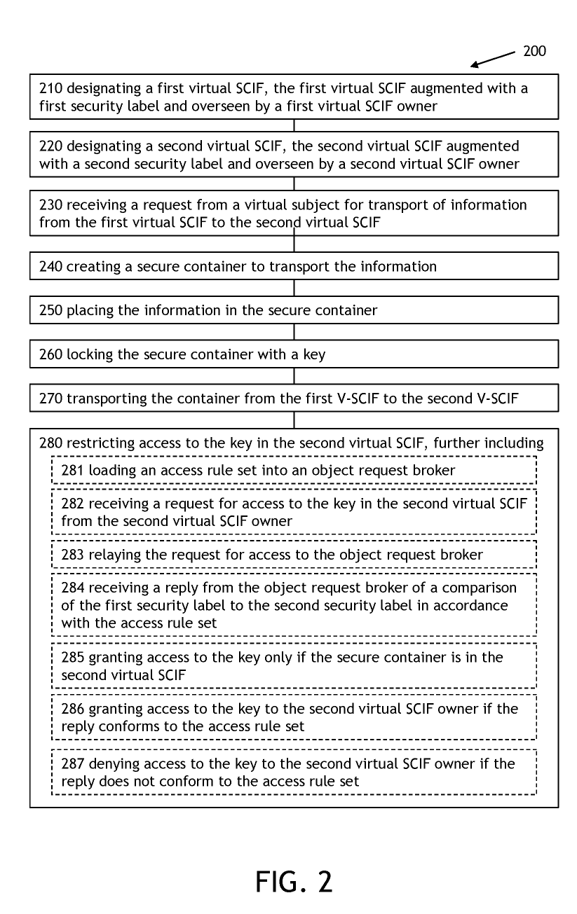

Referring to FIG. 2, method 200 may designate a first virtual SCIF, the first virtual SCIF augmented with a first security label and overseen by a first virtual SCIF owner 210. The overseeing function requires an owner to instantiate the virtual SCIF, manage the virtual SCIF properties, dominate the classification of all data in the virtual SCIF, and regulate and classify all data transported into or out of the virtual SCIF. Method 200 may designate a second virtual SCIF, the second virtual SCIF augmented with a second security label and overseen by a second virtual SCIF owner 220. Method 200 may receive a request from a virtual subject for transport of information from the first virtual SCIF to the second virtual SCIF 230. Method 200 may create a secure container to transport the information 240. Data assigned to a virtual SCIF may not be transferred except via this special secure container.

Method 200 may place the information in the secure container 250, locking the secure container with a key 260. Data may be protected cryptographically and the key may be tied to a particular sensitivity level. In one embodiment, method 200 may employ a trusted guard in each virtual SCIF to perform various virtual SCIF functions such as data enciphering and deciphering, data labeling or label removal, and data transport. The contents of the secure container may be encrypted by either the virtual SCIF key or trusted guard key. In one embodiment, the secure container may have delivery information indicating the destination and delivery schedule. Secure containers may have an expiry property which results in the secure container being destroyed in the event the secure container is not delivered within a specified period of time. In another embodiment, secure containers have an optional property that causes information to destruct immediately after access. The form of the secure container may be any object that may be created in the virtual world. Method 200 may then transport the container from the first virtual SCIF to the second virtual SCIF 270.

Once the data arrives at the destination, method 200 may also restrict access to the key in the second virtual SCIF 280. Method 200 may load an access rule set into an object request broker 281. Method 200 may receive a request for access to the key in the second virtual SCIF from the second virtual SCIF owner 282. Method 200 may relay the request for access to the object request broker 283. Method 200 may receive a reply from the object request broker of a comparison of the first security label to the second security label in accordance with the access rule set 284. Method 200 may grant access to the key only if the secure container is in the second virtual SCIF 285. In one embodiment, the data may be accessible only in rooms with equal security labels. In another embodiment, an attribute of the data determines whether or not it may be removed from a virtual SCIF. Contractors and companies that may be collaborating may each have an instance of a virtual SCIF with equivalent properties and classification levels. Method 200 may grant access to the key to the second virtual SCIF owner if the reply conforms to the access rule set 286. and Method 200 may deny access to the key to the second virtual SCIF owner if the reply does not conform to the access rule set 287.

The virtual SCIF domains may correspond to organizations. For example, Corporation A has a domain, Corporation B has a domain, and DoD has a domain. The sensitivity levels in different domains may be incomparable, thus the rule set may deny access to a SCIF or deny access to the key required to unlock a secure container existing inside a virtual SCIF.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method may be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A computer program product for limiting access to a virtual sensitive compartmented information facility (SCIF) comprising:
computer usable code configured to create a virtual SCIF, the virtual SCIF augmented with a SCIF security label;
computer usable code configured to augment a virtual subject with a subject security label;
computer usable code configured to receive a request for access to the virtual SCIF from the virtual subject;
computer usable code configured to load an access rule set into an object request broker;
computer usable code configured to relay the request for access to the object request broker;
computer usable code configured to receive a reply from the object request broker of a comparison of the SCIF security label to the subject security label in accordance with the access rule set;
computer usable code configured to grant access to the virtual SCIF to the virtual subject if the request conforms to the access rule set; and
computer usable code configured to deny access to the virtual SCIF to the virtual subject if the request does not conform to the access rule set.

2. A computer program product for secure transport of information between virtual sensitive compartmented information facilities (virtual SCIF) comprises:
computer usable code configured to designate a first virtual SCIF, the first virtual SCIF augmented with a first security label and overseen by a first virtual SCIF owner;
computer usable code configured to designate a second virtual SCIF, the second virtual SCIF augmented with a second security label and overseen by a second virtual SCIF owner;
computer usable code configured to receive a request from a virtual subject for transport of information from the first virtual SCIF to the second virtual SCIF;
computer usable code configured to create a secure container to transport the information;
computer usable code configured to place the information in the secure container;
computer usable code configured to lock the secure container with a key;
computer usable code configured to transport the secure container from the first virtual SCIF to the second virtual SCIF;
computer usable code configured to restrict access to the key in the second virtual SCIF, further including:
computer usable code configured to load an access rule set into an object request broker;
computer usable code configured to receive a request for access to the key in the second virtual SCIF from the second virtual SCIF owner;
computer usable code configured to relay the request for access to the object request broker;
computer usable code configured to receive a reply from the object request broker of a comparison of the first security label to the second security label in accordance with the access rule set;
computer usable code configured to grant access to the key only if the secure container is in the second virtual SCIF;
computer usable code configured to grant access to the key to the second virtual SCIF owner if the reply conforms to the access rule set; and
computer usable code configured to deny access to the key to the second virtual SCIF owner if the reply does not conform to the access rule set.
